(19) United States
(12) Patent Application Publication
(10) Pub. No.: US 2012/0253015 A1
(43) Pub. Date: Oct. 4, 2012

(54) SOY PROTEIN CONCENTRATE

(76) Inventor: Daniel Chajuss, Mobile Post Emek Soreq (IL)

(21) Appl. No.: 13/514,852

(22) PCT Filed: Sep. 16, 2010
(86) PCT No.: PCT/IL10/00765

§ 371 Date: Jun. 8, 2012

(30) Foreign Application Priority Data
Jun. 21, 2010 (IL) 206528

(51) Int. Cl. C07K 1/36; C07K 14/415

(52) U.S. Cl. 530/378

(57) ABSTRACT

In one embodiment a process for preparing a soy protein concentrate of good quality and yield from soybean white flakes without the need to screen out fines and dust from the soybeans white flakes before aqueous alcohol extraction is provided. The process includes extracting the soybean white flakes with hexane in a continuous counter current hexane extractor to remove the oil, partially stripping the hexane from the deoiled flakes under mild condition so as not to toast, cook or denature the protein, and without harsh mechanical handling, providing deoiled flakes, and delivering the flakes directly to an aqueous alcohol extractor to extract the residual hexane, sugars and other aqueous alcohol soluble material, to obtain a soy protein concentrate of good quality and yield.

### FIELD OF THE INVENTION

This invention relates to a process to make soy protein concentrate from soybeans and to the soy protein concentrate made accordingly.

### BACKGROUND OF THE INVENTION

Soy protein concentrate is a purified soy protein product that contains minimum 65% protein (N×6.25) and maximum 90% protein on a moisture free basis (Codex Alimentarius Standard 175-1989). Soy protein concentrate is made by removal from defatted soybeans of non-protein components under conditions where the bulk of the proteins are rendered insoluble. The sugars and other low molecular weight constituents are dissolved leaving the protein and the cell wall polysaccharides. Thorough information has been published on industrial soybean protein products including soy protein concentrates and their chemistry, technology and utilization. (Meyer, E W, 1971, Oilseed Protein Concentrates and Isolates, J. Am. Oil Chem. Soc., 48:484-488; Circle, S J and Smith A K, 1972, Processing soy flours, protein concentrates and protein isolates, Chap. 9 in A K Smith and S J Circle (Editors), Soybean Chemistry and Technology, Vol. 1, Proteins, Avi Publishing, Westport, Conn., USA; Liu, K (Editor), 1999, Soybeans Chemistry, Technology and Utilization, Aspen Publishers, Inc., Gaithersburg, Md., USA; Endress, J G, 2001, Soy Protein Products: Characteristics, Nutritional Aspects, and Utilization. AOCS Press, Champaign, Ill., USA; Chajuss, D, 2004, Soy Protein Concentrate: Technology, Properties, and Applications, Chap. 6 in Liu, K (Editor), Soybeans as Functional Foods and Ingredients, AOCS Press, Champaign, Ill. USA.)

The dissolving agents considered over the years to produce soy protein concentrates from defatted soybeans were: hot water leaching of heat denatured defatted soybean; (McAnelly, U.S. Pat. No. 3,142,571), diluted acid leaching at an isoelectric pH of ±4.5; (Sair, U.S. Pat. No. 2,881,076). and aqueous alcohol extraction (Mustakas, G C, Kirk, L D, Griffin, E L, 1962, Flash Desolventizing of Defatted Soybean Meals Washed with Aqueous Alcohol to Yield a High Protein Product, J. Am. Oil Chem. Soc. 39:222-226; Chajuss, Israel Patent IL19168)

The aqueous alcohol extraction process is based on the ability of aqueous solutions of lower aliphatic alcohols (methanol, ethanol, and isopropanol) to extract the soluble fractions of defatted soy flakes without solubelizing its proteins.

Aqueous alcohol extracted (washed) soy protein concentrates were introduced commercially in the early 1960s . Central Soya's Chemurgy Division developed an immersion aqueous alcohol extraction system and at the same times Chajuss of Hayes Ashdod Ltd. introduced a continuous counter current aqueous alcohol extraction system, using for the purpose a solvent extractor wherein the aqueous alcohol solvent phase percolates through successive beds of the defatted, non toasted, spent and dry soybean flakes, commonly known as white flakes, with the solubles-rich solvent phase percolating through the in-coming white flakes and fresh aqueous alcohol solvent contacting the exiting flakes. About 94% of all the soy protein concentrates manufactured worldwide today are made by the continuous counter current aqueous alcohol percolation extraction system introduced by Chajuss. A system that makes a soy protein concentrate, commonly known as traditional soy protein concentrate. The traditional aqueous alcohol extracted soy protein concentrate is manufactured by extracting defatted non-toasted white soybean flakes having a nitrogen solubility index (NSI) of about 50 to 70 with warm aqueous alcohol having about 60% to 70% alcohol. Traditional soy protein concentrate is used in minced meat products, minced fish products, bakery products, dairy products, breakfast cereals, dietetic foods, feed starters, calves milk substitutes, aqua feeds, pet foods, and it can be further converted into textured and functional soy protein concentrates. Roughly 60% to 70% of the traditional soy protein concentrate produced is used for human consumption, the rest being used for calves and piglets milk substitutes, fish feeds and pet foods. A small amount is used for non-food or non-feed applications, e.g. for paper coatings (Chajuss, D, 2004, Soy Protein Concentrate: Technology, Properties, and Applications, Chap. 6 in Liu, K. (Editor) Soybeans as Functional Foods and Ingredients, AOCS Press, Champaign, Ill. USA.)

Traditional soy protein concentrate is generally manufactured from sound clean soybeans that are cracked, dehulled, preferably flaked to thickness of about between 0.25 mm to 0.50 mm, and defatted by non polar solvent such as commercial hexane or SBP (special boiling point) aliphatic hydrocarbon solvents with narrow boiling ranges (hereinafter designated “hexane”). The defatted soybean flakes are desolventized by such methods that do not over heat or denature the defatted flakes that first remove most of the hexane from the wet flakes, by such means as e.g., flash desolventizing system that evaporate most of the hexane at a low temperature in a stream of superheated hexane vapor that retain high NSI in the defatted untoasted white flakes and later stripping the remaining hexane from the desolventized flakes. Flash desolventizing system and other systems of desolventizing are described in the literature (Milligan, E D, Suriano, J F, 1974, System for production of high and low protein dispersibility index edible extracted soybean flakes, J. Am. Oil Chem. Soc. 51:158-61; Becker, K W, 1983, Current trends in meal desolventizing. J. Am. Oil Chem. Soc. 60:162-169; Anderson and Ozer, US Patent Application US20030070317 “Apparatus and method for removing solvent from particulate”).

Processes for the removal of hexane for the production of high NSI defatted untoasted soybean white flakes include as a rule a desolventizing stage that remove most of the hexane solvent and a stripping stage that removes out the remaining solvent. For example, in flash desolventizing system, the removal of hexane from the flakes passing a flash line tube is not finished in the flash line tube and the hexane left in the flakes can reach above 1%. The remaining hexane is usually removed after the flash line by a stripping process that removes almost the entire hexane from the white flakes, leaving only trace amounts of hexane in the out-coming white flakes. The stripping is achieved by agitating or stirring of the flash desolventized flakes and treating the stirred flakes with either dry superheated steam or wet saturated steam under carefully controlled conditions of steam temperature, pressure, flow rate, and moisture content. The stripping of the remaining hexane cause much breakage to the white flakes and the white flakes that are at this point dry, defatted, non-toasted, spent, solvent-free, white soybean flakes are now normally transported to intermediate storage tanks for subsequent sifting of the fines and dust. The fines and dust-free defatted and non-toasted white soybean flakes are further conveyed afterwards to the inlet of the aqueous alcohol extractor for extraction of the sugars and other low molecular weight constituents, leaving the protein and the cell wall polysaccharides that constitute soy protein concentrate. The hexane stripping operation as well as the mechanical handling, conveying, storage and transportation of the dry, defatted, non-toasted, spent, solvent-free white soybean flakes result in a lot of breakage to the white flakes due to their fragility. The breakage consists of large amount of fines and dust with very small particles in a wide range of sizes.

Konwinski in U.S. Pat. No. 5,097,017, “Process for making soy protein concentrate”, describes the impediments associated with the fines and dust contained in the defatted and fully desolventized white soybean flakes and the considerable difficulties to operate aqueous alcohol extraction caused by the fines and dust in addition to the grim necessity to screen the fines and dust before the aqueous alcohol extraction. Konwinski proposed solution to the disposal of the screened fines and dust by agglomerating either dusty defatted soybean flakes or the fines and dust in a screw device with substantially no die restriction at the discharge end and thereafter extracting the agglomerated material with 55% to 75% aqueous ethanol. Konwinski, however, does not, however, eliminate the need to screen the fines and dust out of the hexane extracted, defatted and desolventized white flakes and his proposed solution brings about added expenses and extra energy consuming operations. A detailed examination of the literature and of the problems associated with the presence of fines and dust in the defatted desolventized white soybean flakes is provided by Konwinski, which is hereby incorporated in its entirety.

The defatted, non-toasted, spent, solvent-free white soybean flakes after the stripping, mechanical handling and intermediary storage typically contain from about 15% to 50% of fines and dust. To facilitate an appropriate aqueous alcohol extraction operation, the white flakes must be, and are normally, screened to remove the fines and dust before they are placed in the aqueous alcohol extractor. Fines and dust in the white flake feed stream to the aqueous alcohol extraction cause problems which are manifold and quite severe. In practice, as noted herein before, the problem of the fines and dust is resolved by screening the white flake stream just prior to extraction. This is an unsatisfactory resolution of the problem since it generates a significant by-product stream which must be disposed of at a reasonable price to maintain an economic processing operation. Further, such a stream will vary in volume with changing flake lots, making the problem of uniform disposal all the more difficult. Furthermore the sifting out of the fines and dust from the defatted and desolventized white soybean flakes will decrease the protein content in the defatted flakes going into the aqueous alcohol extractor as a higher protein content is shifted to the fines and dust fraction and the protein content of the soy protein concentrate obtained would be lower.

An aqueous alcohol extracted soy protein product, similar to soy protein concentrate, that contains about 60% protein on dry solids basis has been made by conversion by expander of the oil containing soybeans flakes into extruded porous pellets that are commonly known as collets. The collets, which are firmer and stronger than the flakes, are extracted by hexane, then desolventizing to remove the hexane using as a rule hexane Desolventizer-Toaster and Drier-Cooler. Subsequently the collets are extracted with 50% to 75% aqueous alcohol to remove sugars, desolventized to remove the aqueous alcohol out of the collets to obtain a protein enriched soy product. As heating is much involved in the process, the product thus made is of inferior quality as compared to a soy protein concentrate made out of white flakes (lower protein content, reduced nutritional value, darker color and taste). Because of its lower manufacturing cost relatively to traditional soy protein concentrate, the product is mainly used for aquaculture, where color, taste, protein content and quality are of lesser importance. However, soy protein product thus made, is generally considered inappropriate for human food utilization and also for some feeding purposes.

Kellens and Van Doosselaere in British Patent Application GB0811380 “Vegetable protein concentrate” (and in the related US Patent Application US20090317512) disclose a process for preparing a vegetable protein concentrate from oleaginous vegetable material that comprises the steps of: a) pre-treating the oleaginous vegetable material to open the cells; b) extracting the pre-treated vegetable material in a first extractor with an apolar solvent, to produce a solvent-wet, defatted vegetable material; c) contacting the defatted vegetable material with aqueous ethanol with an ethanol concentration of at least 80% by weight that has the composition of the ethanol/water azeotrope.; d) wetting the ethanol-wet, defatted vegetable material with aqueous ethanol; e) extracting the vegetable material in an ultimate extractor to produce a a solvent-wet proteinaceous material; f) desolventising said solvent-wet proteinaceous material to produce a vegetable protein concentrate. Teachings of British Patent Application GB0811380 are known to people versed in the art (See for example: D. R. Erickson (Editor) Practical Handbook of Soybean Processing and Utilization; 1995 and following printed editions, AOCS Press, Champaign, Ill., USA; and e.g., the teachings of U.S. Pat. No. 3,365,440 and U.S. Pat. No. 3,734,901, and alike).

### SUMMARY OF THE INVENTION

The present invention provides a simplified novel process to produce improved soy protein concentrate with good yield from soybeans without a need to remove fines and dust from the defatted white flakes prior to undergoing aqueous alcohol extraction. The invention also relates to soy protein concentrate prepared by this method.

### DETAILED DESCRIPTION OF THE INVENTION

We have discovered a novel process whereby soy protein concentrate of good quality and yield is attained by a simple, easy, efficient, continuous, low cost process, with no need to screen out fines and dust, or to agglomerate the same. The invention described herein is concerned with a significant improvement in the aqueous ethanol extraction process for making soy protein concentrates.

In the present state of art, soy protein concentrate is commonly made from high quality soybean (identical the USDA grade number 1 or number 2 yellow soybeans) by the following production steps: drying, tempering, cleaning, classification, cracking, dehulling , conditioning and flaking. The flakes are extracted by hexane to remove the oil and then desolventized to remove the solvent by such methods able to produce dehulled, non toasted, deoiled, desolventized soybean flakes with high NSI, commonly known as white flakes. The white flakes are typically produced, but not exclusively, by a flash desolventizing system, consisting of a pneumatic-conveying desolventizing tube, a cyclone flake separator, a hexane blower and a hexane vapor heater arranged in a closed-loop system in which superheated vapor is constantly circulated. Solvent-wet flakes are fed continuously into the desolventizing tube from the hexane extractor through a rotary seal or a variable speed conveyor to the circulating vapor stream where the most of the solvent is removed down to about 1%. The desolventized flakes are then discharged into a stripping system wherein the stripping is achieved by agitating or stirring of the flash desolventized flakes and treating the stirred flakes with either dry superheated steam or wet saturated steam under carefully controlled conditions of steam temperature, pressure, flow rate, and moisture content to ensure removal of the hexane solvent and to produce white soybean flakes, dry, defatted and solvent free, with only minute traces of hexane, having a closely controlled protein solubility with a typical nitrogen solubility index (NSI) range of about 50 to 70. The white flakes are now transferred to operational storage bins, screened to remove the fines and dust (e.g., about 15% to 50%, when screened on 1 mm sieve) and the large particles are conveyed to aqueous alcohol extractor to extract and remove the aqueous alcohol soluble material to obtain after the aqueous alcohol desolventizing and usually milling soy protein concentrate.

We surprisingly found out that by omitting the stripping operation, the mechanical handling and screening, the desolventized white flakes that may still having about 1% hexane delivered by the flash line tube cyclone (preferably through a rotary seal) directly into the inlet of the aqueous alcohol extractor, the flakes could be handled in the aqueous alcohol extractor without any difficulties. The extraction by aqueous ethanol is thus made without any ill consequences and soy protein concentrate of good quality is produced.

We further found that the extraction by aqueous alcohol of the flash desolventized flakes that contain about 1% of hexane actually need only few simple modifications in the production procedures. In fact there are no problems to extract the oil with hexane containing slight amount of alcohol and there are no problems to extract sugars with aqueous alcohol that contain some little amount of hexane. The hexane is preferably separated from the aqueous alcohol in the plant by various means known per se including decantation membrane separation, et cetera. The hexane and alcohol vacuum systems may preferably be achieved by vacuum pumps and not by jet ejectors to prevent dilution of alcohol with the steam vapors and to enable easy recuperation of alcohol. Likewise, a low temperature brine refrigeration system that is installed for alcohol recovery can also preferably serve to ensure easy and simple recovery of both the hexane and the alcohol solvent.

This discovery is not limited to flash desolventizing system but apply to all desolventizing systems that can provide for, in one or more stages of operation non toasted white flakes with high NSI abd without any substantial breakage of the flakes to fines and dust, with remaining hexane of preferably not more than about 1% in the desolventized flakes.

The invention will be illustrated by the following non-limiting example.

### EXAMPLE

Two industrial batches of soy protein concentrate were prepared each from 100 ton of soybeans taken from the same storage silos having the following specifications: No. 2 USDA Grade yellow soybeans. Moisture 11%, protein content 38%, NSI 85, oil 18%. The trials took place in an industrial facility of Hayes (Ashdod) Ltd.

TRIAL I, Utilizing the present state of art—The first 100 ton batch of soybeans was processed in an oil extraction plant using preparation steps including cracking, dehulling, conditioning and flaking into 0.38 mm thick flakes. The flakes were extracted by hexane in a continuous percolation type counter current hexane extractor to remove the oil, desolventized by flash desolventizing, discharged into a stripping system wherein the stripping was achieved by stirring of the flash desolventized flakes and removal of the remaining hexane by dry superheated steam. The fully desolventized flakes were passed into a intermediate storage bin, conveyed into a plain square sifter having 1 mm holes to remove the fines and dust and the flakes that were free of fines and dust were conveyed into the aqueous alcohol extractor inlet to extract the sugars and other aqueous alcohol soluble material that was now dried and desolventized to obtain soy protein concentrate.

RESULTS: Out of 100 ton of soybeans after the preparation steps including cracking, cleaning and dehulling, conditioning and flaking into 0.38 mm thick flakes. about 72 ton of fully desolventized white flakes were obtained. Out of these white flakes about 12 ton of fines and dust below 1 mm (US Standard Screen #18 0.0394 Inch sieve) were sifted out and discarded and out of about the 60 ton of the white flakes that left for alcohol extraction about 43 ton of soy protein concentrate having after micro milling about: 8% Moisture, 69% Protein (N×6.25%) on dry basis and 1.0% Fat.

TRIAL II, Utilizing the teachings of the present patent application—The second batch of 100 ton of soybeans was processed in an oil extraction plant after the preparation steps including cracking, cleaning and dehulling, conditioning and flaking into 0.38 mm thick flakes. The flakes were extracted by hexane in a continuous percolation type counter current hexane extractor to remove the oil. The flakes were now partially desolventized by flash desolventizing, to obtain white flakes still having about 1% hexane that were delivered by the flash line tube cyclone through a rotary seal directly into the inlet of the aqueous alcohol extractor to extract the sugars and other aqueous alcohol soluble material that was now dried and desolventized to obtain soy protein concentrate.

RESULTS: Out of 100 ton of soybeans after cleaning and dehulling about 51 ton of soy protein concentrate having after micro milling about: 8% Moisture, 70% Protein (N×6.25%) on dry basis and 1.0% Fat.

1. A process for preparing soy protein concentrate of good quality and yield from soybean white flakes without the need to screen out fines and dust from the soybeans white flakes before aqueous alcohol extraction, comprising,
extracting the soybean white flakes with hexane in a continuous counter current hexane extractor to remove the oil,
partially stripping the hexane from the deoiled flakes under mild condition so as not to toast, cook or denature the protein, and without harsh mechanical handling, providing deoiled flakes, and
delivering the flakes directly to an aqueous alcohol extractor to extract the residual hexane, sugars and other aqueous alcohol soluble material, to obtain a soy protein concentrate of good quality and yield.

2. A process as in claim 1 wherein the deoiled flakes are partially stripped in a flash desolventizing line and conveyed directly into an aqueous alcohol extractor for aqueous alcohol extraction to produce soy protein concentrate.

3. A process as in claims 1 and 2 wherein the stripped deoiled flakes contain about 1% hexane before entering the aqueous alcohol extractor.

4. A process essentially similar to any process described in claims 1, 2 and 3.

5. A soy protein concentrate prepared from soybean white flakes in accordance with any one of claims 1 to 4, comprising approximately a 51% yield with an 8% moisture content, 70% protein (N×6.25%) on dry basis and 1% fat.

6. Soy protein concentrate made essentially according to a process of any of the preceding claims.
